(19) United States
(12) Patent Application Publication
(10) Pub. No.: US 2026/0172648 A1
(43) Pub. Date: Jun. 18, 2026

(54) METHOD, APPARATUS, DEVICE AND STORAGE MEDIUM FOR CONTENT GENERATION

(71) Applicants: Lemon Inc., Grand Cayman (KY); Beijing Zitiao Network Technology Co., Ltd., Beijing (CN)

(72) Inventors: Lingshuang KONG, Culver City, CA (US); Lingxuan SHEN, Beijing (CN); Zhenan LI, Beijing (CN); Weijian CHEN, Beijing (CN)

(21) Appl. No.: 19/423,966

(22) Filed: Dec. 17, 2025

(30) Foreign Application Priority Data
Dec. 18, 2024 (WO) PCT/CN2024/140414

(51) Int. Cl. H04N 21/81; H04N 21/2743; H04N 21/431

(52) U.S. Cl. CPC H04N 21/816; H04N 21/2743; H04N 21/4318

(57) ABSTRACT

A method includes: presenting an editing interface for first media content, the editing interface comprising a generation entry; obtaining, based on triggering of the generation entry, a generation request indicating at least one generation parameter; providing second media content in the editing interface, the second media content being dynamic media content generated based on the first media content and the at least one generation parameter; and posting, in response to a posting request received in the editing interface, a work corresponding to the dynamic media content.

### CROSS-REFERENCE

The present application claims priority to PCT Application No. PCT/CN2024/140414, filed on Dec. 18, 2024, and entitled “METHOD, APPARATUS, DEVICE AND STORAGE MEDIUM FOR CONTENT GENERATION”, the entirety of which is incorporated herein by reference.

### FIELD

Example embodiments of the present disclosure generally relate to the field of computers, and in particular, to a method, an apparatus, a device, and a computer-readable storage medium for generating content.

### BACKGROUND

In recent years, with the development of the Internet, more and more users perform interactive activities in a network platform, for example, posting or browsing media content in a network platform. When a user posts media content in a traditional network platform, the media content is usually presented in a form of a text, a picture, or a video, and the user may edit the media content. However, in the process of editing the media content, the user usually can perform simple editing operations only by adding text, stickers and the like, and the editing mode is relatively monotonous and the interactivity and entertainment value are also relatively low.

### SUMMARY

In a first aspect of the present disclosure, there is provided a method for content generation, comprising: presenting an editing interface for first media content, the editing interface comprising a generation entry; obtaining, based on triggering of the generation entry, a generation request indicating at least one generation parameter; providing second media content in the editing interface, the second media content being dynamic media content generated based on the first media content and the at least one generation parameter; and posting, in response to a posting request received in the editing interface, a work corresponding to the dynamic media content.

In a second aspect of the present disclosure, there is provided an apparatus for content generation, comprising: a presentation module configured to present an editing interface for first media content, the editing interface comprising a generation entry; an obtaining module configured to obtain, based on triggering of the generation entry, a generation request indicating at least one generation parameter; a providing module configured to provide second media content in the editing interface, the second media content being dynamic media content generated based on the first media content and the at least one generation parameter; and a posting module configured to post, in response to a posting request received in the editing interface, a work corresponding to the dynamic media content.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which some embodiments of the present disclosure can be implemented;

FIGS. 2A to 2O illustrate example interfaces in accordance with some embodiments of the present disclosure;

FIG. 3 illustrates a flowchart of an example process for content generation according to some embodiments of the present disclosure;

FIG. 4 illustrates a schematic structural block diagram of an example apparatus for content generation according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for example purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including/comprising” and the like should be understood to include “including/comprising but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data acquisition, acquisition, processing, processing, interaction, use and the like are performed on the premise that the user knows and confirms. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processed only within a specified or agreed range. The user rejection for personal information other than necessary information required by the basic function does not affect use of the basic function by the user.

As briefly mentioned above, with the development of the Internet, more and more users perform interactive activities in a network platform, for example, posting or browsing media content in a network platform. When a user posts media content in a traditional network platform, the media content is usually presented in a form of a text, a picture, or a video, and the user may edit the media content. However, in the process of editing the media content, the user usually can perform simple editing operations only by adding text, stickers and the like, and the editing mode is relatively monotonous and the interactivity and entertainment value are also relatively low.

Embodiments of the present disclosure provide a solution for content generation. According to the solution, an editing interface for first media content may be presented, and the editing interface comprises a generation entry. Based on triggering of the generation entry, a generation request is obtained, and the generation request indicates at least one generation parameter. Second media content is provided in the editing interface, and the second media content is dynamic media content generated based on the first media content and the at least one generation parameter. In response to a posting request received in the editing interface, a work corresponding to the dynamic media content is posted.

In this manner, embodiments of the present disclosure can generate dynamic media content based on the first media content based on the received operation. Therefore, according to the embodiments of the disclosure, the presented information and effect of the media content can be enriched in the dynamic media content while the original presented information and effect of the first media content are retained, and the experience feeling and the enjoyment of the user interaction can be effectively improved through the dynamic effect.

Various example implementations of this solution are described in detail below in conjunction with the accompanying drawings.

### Example Environment

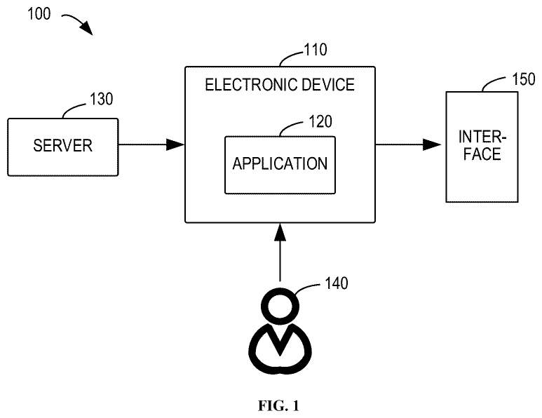

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to: a video application, a social application, or other suitable application. A user 140 may interact with the application 120 via the electronic device 110 and/or its attachment device.

In the environment 100 of FIG. 1, if the application 120 is active, the electronic device 110 may present, via the application 120, an interface 150 for supporting interface interaction.

In some embodiments, the electronic device 110 communicates with a server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide a background service for an application 120 supporting interface interaction in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

Some example embodiments of the disclosure will be described below with continued reference to the accompanying drawings.

### Example Interaction

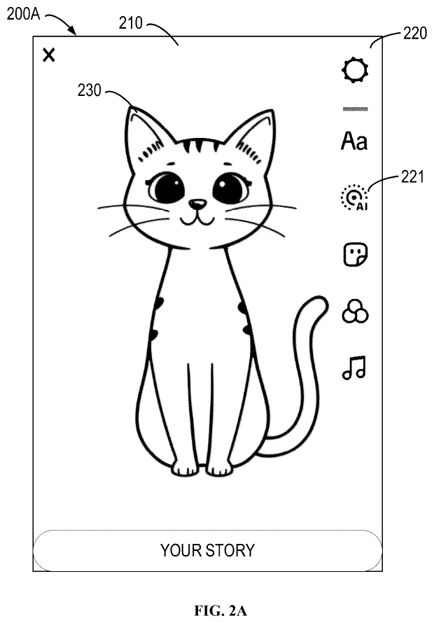

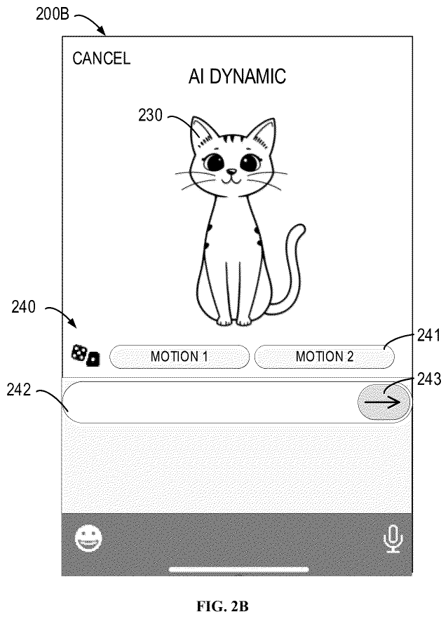

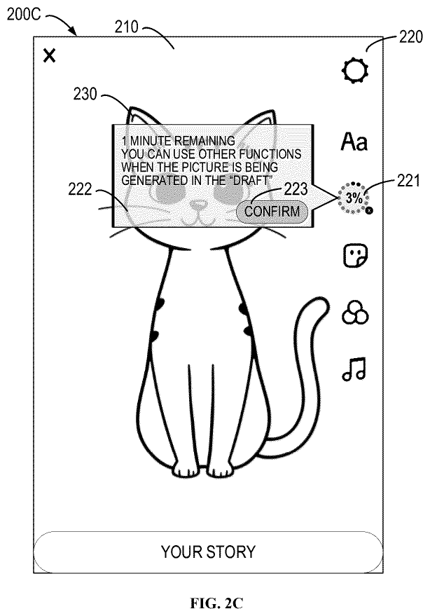

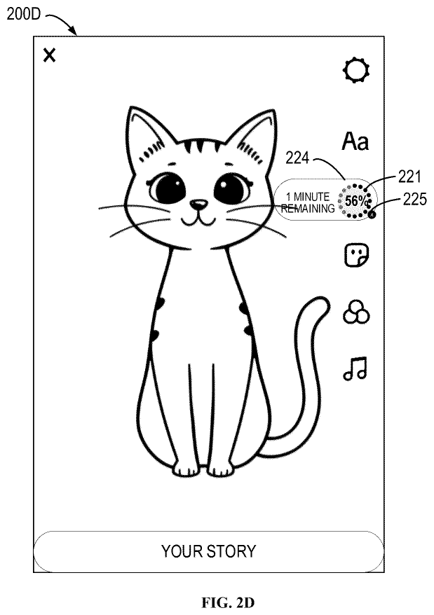

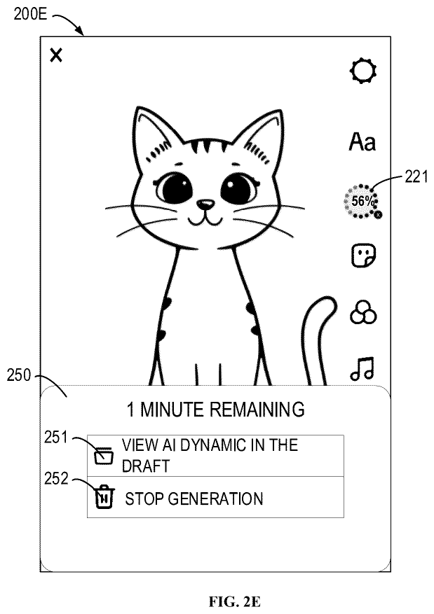

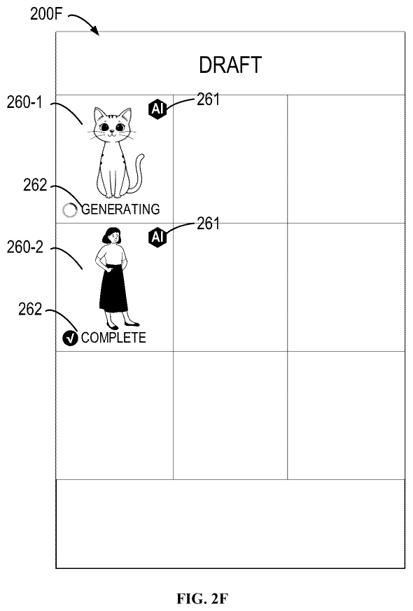

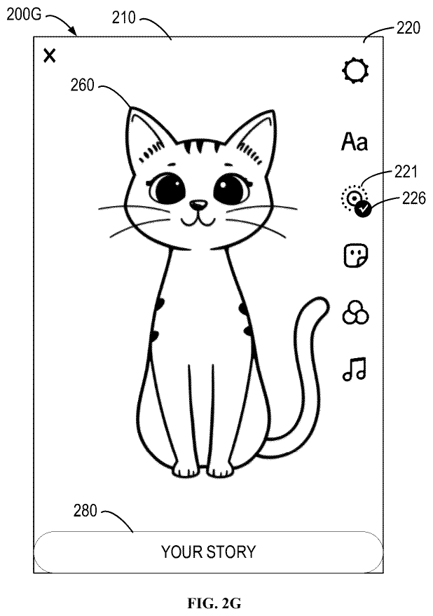

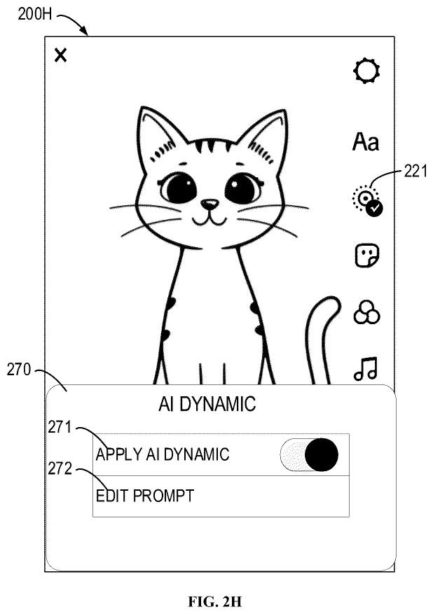

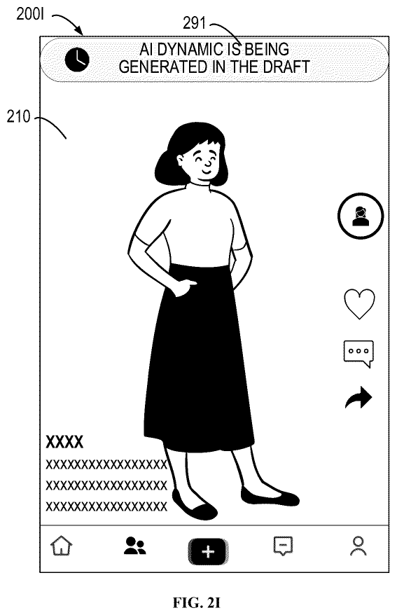

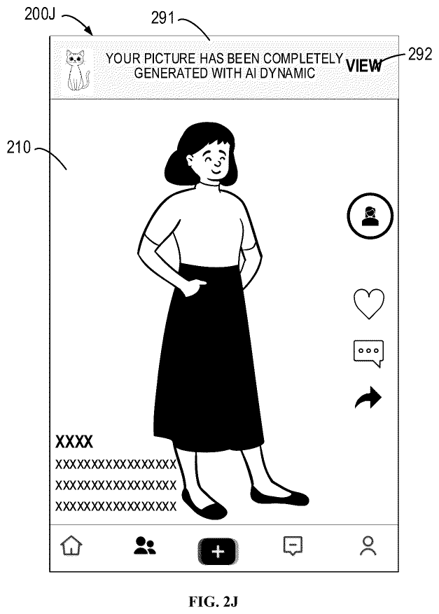

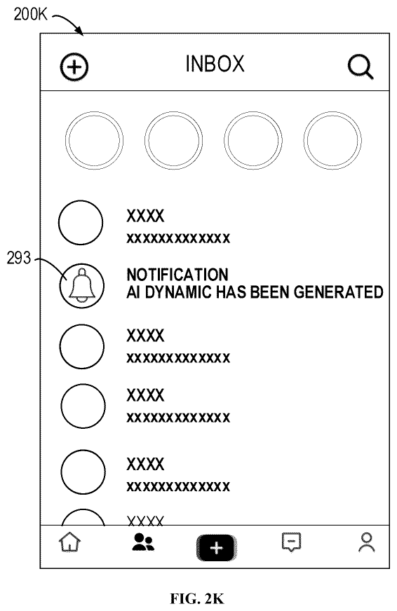

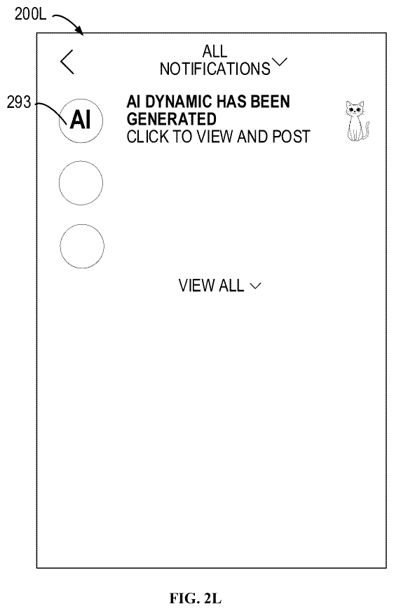

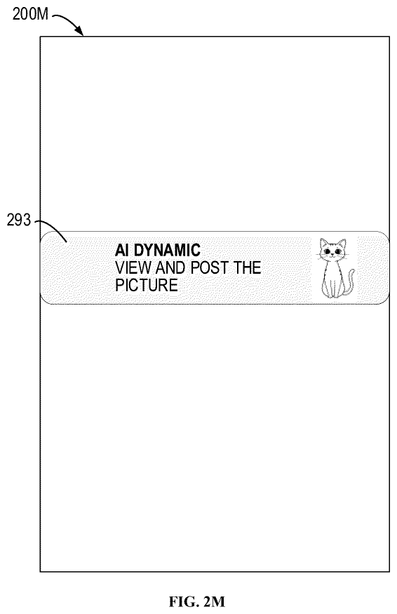

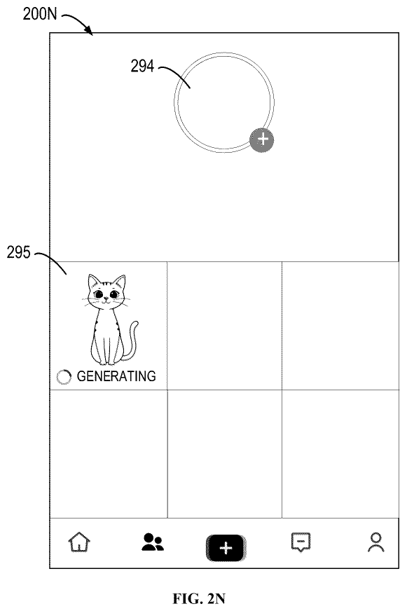

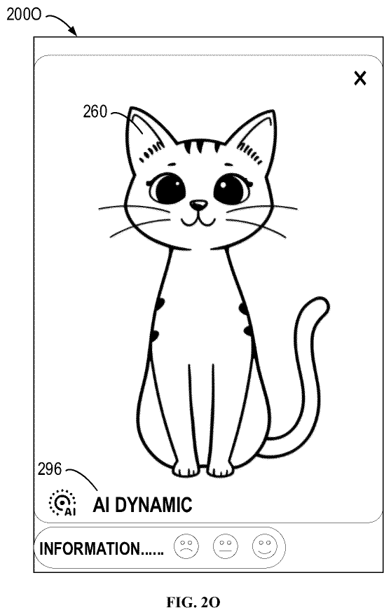

FIGS. 2A to 2O illustrate example interfaces 200A to 200F, in accordance with some embodiments of the present disclosure. The interface 200A to the interface 200O may be provided, for example, by the electronic device 110 shown in FIG. 1.

In some embodiments, as shown in FIG. 2A, the editing interface 200A includes a content area 210, and the electronic device 110 may present first media content 230 in the content area 210. As an example, the content area 210 may present a real-time image, that is, the first media content 230, acquired by the user through the image acquisition device. The content area 210 may also present a candidate image, that is, the first media content 230, uploaded by the user. Such a set of candidate images may include, for example, an image library local to the electronic device 110, or an associated online image library. It should be understood that the acquisition and use of such candidate images is performed with user awareness and authorization. As an example, the first media content 230 may include a picture.

Additionally, the electronic device 110 may further determine whether an image (for example, a captured image or an uploaded image) provided by the current user meets a predetermined requirement. Such predetermined requirements may be related to, for example, content, quality, and/or size of the image. For example, the predetermined requirement may include that a specific type of object needs to be included in the image.

In some embodiments, the editing interface 200A may also include a control area 220 that may provide one or more interaction controls associated with the media content presented in the content area 210. As an example, the control in the control area 220 may be used to edit the first media content 230, for example, add a text, an expression, a soundtrack, or adjust a size, a filter, and the like of the first media content 230, which is not limited herein.

In some embodiments, a generation entry 221 is provided in the control area 220, and the electronic device 110 may receive a first operation of the user on the generation entry 221. For example, the electronic device 110 may receive a user's click or other appropriate action on the generation entry 221. Accordingly, in response to receiving the first operation, the electronic device 110 may present the interface 200B as shown in FIG. 2B.

In some embodiments, as shown in FIG. 2B, the editing interface 200B includes a generation control area 240, and the electronic device 110 may receive a second operation for the generating control area 240 and obtain a generation request indicating at least one generation parameter.

In some embodiments, the generation control area 240 includes selection control 241. As an example, one or more default motion options are presented in the selection control 241. The electronic device 110 may obtain, via a selection of the selection control 241 by the user, a prompt for generating second media content.

In some embodiments, the electronic device 110 may analyze the image content of the first media content 230, for example, obtain image information (e.g., main body content and environmental content included in the image) in the first media content 230, and based on that generate a motion option for the selection control 241. As an example, an option for the selection control 241 indicates a motion associated with the main body content in the first media content 230. The main body content may include one or more objects, such as a person, two cats, a plurality of identical or different animals or items, such as fallen leaves on a tree, flowers in a garden, and the like. Correspondingly, the motion associated with the predetermined object may be actions such as laughing, crying, dancing and the like performed by the person, actions such as running, jumping and interaction of the cat, falling of fallen leaves on the tree, blossom or withering of flowers, etc., which is not limited herein. Thus, the dynamic effect of the second media content can be associated with the image content itself of the first media content 230.

In some embodiments, the generation control area 240 further includes an input control 242. As an example, the electronic device 110 may obtain according to inputted content, via a user's input operation on the input control 242, a prompt for generating the second media content. For example, when the main body content includes a cat, the motion option generated by default may be limited to rolling over, jumping, etc. Through the input control 242, the user may input content such as “one cat dancing” to cause the second media content to present the described dynamic effect. The user may customize, through the input content, the prompt used to generate the second media content, that is, customize the motion of the main body content in the image of the first media content 230, thereby enriching the dynamic effect of the generated second media content.

In some embodiments, the generation control area 240 also includes a launching control 243. The electronic device 110 may receive a third operation of the user on the launch control 243. For example, the electronic device 110 may receive a user's click or other appropriate action on the launch control 243. Accordingly, in response to receiving the third operation, the electronic device 110 may present the interface 200C as shown in FIG. 2C.

In some embodiments, in response to receiving the third operation, that is, in response to obtaining the generation request, the electronic device 110 updates the style of the generation entry 211 to indicate the processing state of the generation request. As shown in FIG. 200C, the editing interface 200C includes the content area 210 and the control area 220. The generation entry 221 and other control(s) are provided in the control area 220, and during the generation process, the user may still be able to edit the media content being generated through other control(s).

In some embodiments, as shown in FIG. 2C, before processing of the generation request is completed, the generation entry 221 presents generation progress information in a form of a progress ring. On the one hand, progress information is represented in a percentage text form (for example, 3%) in the progress ring. On the other hand, the progress ring includes a plurality of progress points, wherein a progress point with a darker color indicates a completed progress, a progress point with a lighter color indicates an incomplete progress, such that the progress information is represented in a form of an intuitive image. As an example, the progress information may include a completed progress (e.g., 50%) indicating the generation process, a remaining progress of the generation process (e.g., remaining time), and so forth. It should be understood that the progress information may be presented in any suitable form, examples of which may include, but are not limited to, a progress bar, a percentage number or other image, a dynamic effect, and the like.

In some embodiments, as shown in FIG. 2C, before processing of the generation request is completed, a prompt box 222 is associated with the generation entry 221 to present state information. The prompt box 222 is presented over the content area 210 in a transparent or semi-transparent form to present the state information in a highlighted way. The state information indicates a duration of remaining processing of the generation request, e.g., 1 minute remaining. The state information may also prompt information related to the generation, for example, “when the photo is being generated in the “draft”, you can use other functions” to prompt the generation progress to the user, and prompt that the generation process can be performed in background and will not affect the normal use of the user, etc., thereby helping the user to quickly know and grasp the content generation method, and improving the user experience.

In some embodiments, the prompt box 222 further includes a confirmation control 223. The electronic device 110 may receive a fourth operation of the confirmation control 223 by the user. For example, the electronic device 110 may receive a user's click or other appropriate action on the confirmation control 223. Correspondingly, in response to receiving the fourth operation, the prompt box 222 is no longer displayed, and the electronic device 110 may present the interface 200D shown in FIG. 2D.

In some embodiments, as shown in FIG. 2D, before processing of the generation request is completed, the generation entry 221 presents the generation progress information in a form of a progress ring, and the prompt box 224 is associated with the generation entry 221 to present state information only indicating a duration of remaining processing of the generation request, for example, 1 minute remaining. The content presented in the prompt box 224 is reduced, so that the area occupied by the prompt box 224 in the interface 200D is small to avoid blocking of the content area 210, so that the user can conveniently view or edit the first media content 230 of the content area 210 in the generation process.

In some embodiments, before processing of the generation request is completed, the interface 200D further includes a closing control 225 associated with the generating entry 221. The electronic device 110 may receive a fifth operation of the user on the generation entry 221. For example, the electronic device 110 may receive a user's click or other appropriate action on the generation entry 221. Accordingly, in response to receiving the fifth operation, the electronic device 110 may present the interface 200E as shown in FIG. 2E.

In some embodiments, as shown in FIG. 2E, before processing of the generation request is completed, a viewing panel 250 is presented in the interface 200E in response to a selection of the generation entry 221 associated with the closing control 225. The viewing panel 250 includes a first entry 215 and/or a second entry 252. For example, the electronic device 110 may receive a user's click or other appropriate operation on the first entry 251, and in response to the user's operation on the first entry 251, the electronic device 110 may present a draft viewing interface 200F as shown in FIG. 2F. The electronic device 110 may receive a user's click or other appropriate action on the second entry 252, and in response to the user's operation on the second entry 252, the electronic device 110 may stop processing the generation request, and return to the interface 200A shown in FIG. 2A.

In some embodiments, as shown in FIG. 2F, the electronic device 110 may present one or more pieces of media content in the draft viewing interface 200F. The one or more pieces of second media content 260 include the dynamic media content generated by the content generation method according to the first media content 230 and the at least one generation parameter.

In some embodiments, the electronic device 110 may also present in the draft viewing interface 2F a processing state of a set of historical generation requests, the set of historical generation requests indicating generation of dynamic media content based on static media content. The set of historical generation requests includes the generation request associated with the first media content. As an example, the second media content 260 carries a generation mark 261 (e.g., an AI mark) indicating that the second media content 260 is dynamic media content generated according to the first media content 230 and the at least one generation parameter. The second media content 260 also carries a progress mark 262 representing the generation progress of the second media content 260. For example, the second media content 260-1 is still being generated, and the second media content 260-2 has been generated completely.

In some embodiments, in response to the second media content 260 having been generated completely, the electronic device 110 may present the interface 200G as shown in FIG. 2G. As shown in FIG. 2G, the editing interface 200G includes a content area 210. The electronic device 110 may present the second media content 260 in the content area 210, and the second media content 260 is automatically played in the content area 210. As an example, the second media content may be a dynamic image or a video.

In some embodiments, as shown in FIG. 2G, the editing interface 200G may also include a control area 220 that may provide one or more interaction controls associated with the media content presented in the content area 210. As an example, a control in the control area 220 may be used to edit the second media content 260, for example, add a text, an expression, a soundtrack, or adjust a size and a filter of the second media content 260 in the second media content 260, which is not limited herein.

In some embodiments, as shown in FIG. 2G, in response to the second media content 260 having been generated completely, the style of the generation entry 211 is updated to indicate the processing state of the generation request. After the second media content 260 has been generated, the interface 200G further includes a completion mark 226 associated with the generation entry 221 to indicate that the processing state of the generation request of the second media content 260 is completion. The electronic device 110 may receive a sixth operation of the user on the generation entry 221. For example, the electronic device 110 may receive a user's click or other appropriate action on the generation entry 221. Accordingly, in response to receiving the sixth operation, the electronic device 110 may present the interface 200H as shown in FIG. 2H.

In some embodiments, as shown in FIG. 2H, after the second media content 260 has been generated, a dynamics panel 270 is presented in the interface 200H in response to a selection of the generation entry 221 associated with the completion mark 226. The dynamics panel 270 including a dynamics switch 271 (applying AI dynamic) and/or an editing control 272. The electronic device 110 may receive an enabling operation of the user on the dynamics switch 271, and in response to the enabling operation on the dynamics switch 271, the electronic device 110 may present the generated second media content 260 in the content area 210. The electronic device 110 may receive a disabling operation of the user on the dynamics switch 271, and in response to the disabling operation on the dynamic switch 271, the electronic device 110 may present the first media content 230 in the content area 210. The electronic device 110 may receive a click or other appropriate operation on the editing control 272 by the user, and in response to the operation on the editing control 272, the electronic device 110 may present the interface 200B shown in FIG. 2B, to enable the user to edit the media content again.

In some embodiments, as shown in FIG. 2G, the interface 200G further includes a posting control 280 configured to post a work corresponding to the dynamic media content. The electronic device 110 may receive a seventh operation of the user on the posting control 280. For example, the electronic device 110 may receive a click of the post control 280 by the user or other appropriate operations, that is, receive a posting request. Correspondingly, in response to receiving the seventh operation, the electronic device 110 may post the work corresponding to the dynamic media content. If the dynamics switch 271 is in an enabled state, the work corresponding to the dynamic media content is a work corresponding to the second media content 260; and if the dynamics switch 271 is in a disabled state, the work corresponding to the dynamic media content is a work corresponding to the first media content 230.

Based on the processes described above, in this manner, embodiments of the present disclosure can generate dynamic media content based on the first media content based on the received operation. Therefore, according to the embodiments of the disclosure, the presented information and effect of the media content can be enriched in the dynamic media content while the original presented information and effect of the first media content are retained, and the experience feeling and the enjoyment of the user interaction can be effectively improved through the dynamic effect.

In some embodiments, the generation request in the foregoing content generation method may be processed asynchronously by the electronic device 110, and the processing of the generation request is independent of whether the editing interface is in an active state.

In some embodiments, the content generation method further includes: before processing of the generation request is completed, in response to the user exiting the editing interface, processing of the generation request does not stop and the generation continues in the “draft”. At this time, the electronic device may present a viewing interface 200I shown in FIG. 2I.

In some embodiments, as shown in FIG. 2I, the viewing interface 200I includes the content area 210. The electronic device 110 may present media content in the content area 210. In other words, the user may view other media content or perform other operations in the electronic device 110 while the generation request is being processed.

In some embodiments, as shown in FIG. 2I, the viewing interface 200I further includes a notification bar 291, and before processing of the generation request is completed, the notification bar 291 presents the processing state of the generation request in a text form, for example, the “AI dynamic is being generated in the draft” indicates that the processing of the generation request is still not completed.

In some embodiments, the content generation method further includes: in response to completion of processing of the generation request, presenting a reminder message; and in response to a predetermined operation on the reminder message, presenting the generated second media content on the editing interface.

In some embodiments, as shown in FIG. 2J, the viewing interface 200J further includes a notification bar 291. In response to completion of processing of the generation request, the notification bar 291 presents the processing state of the generation request in a text form, for example, the “your picture has been generated completely with AI dynamic” indicates that processing of the generation request has been completed.

In some embodiments, as shown in FIG. 2J, the notification bar 291 further includes a viewing control 292 for viewing the generated second media content 260. The electronic device 110 may receive an eighth operation of the user on the viewing control 292. For example, the electronic device 110 may receive a click or other suitable operation of the user on the viewing control 292, that is, receive the posting request. Accordingly, in response to receiving the eighth operation, the electronic device 110 may present the interface 200G as shown in FIG. 2G. The second media content 260 is presented in the content area 210.

In some embodiments, as shown in FIG. 2K, an inbox interface 200K is used to receive information. In response to completion of processing of the generation request, a reminder message 293 is presented in the inbox interface 200K informing the user that the second media content 260 has been generated. The electronic device 110 may receive a ninth operation of the reminder message 293 by the user. For example, the electronic device 110 may receive a click or other suitable operation of the user on the reminder message 293, that is, receive a posting request. Accordingly, in response to receiving the ninth operation, the electronic device 110 may present the interface 200G as shown in FIG. 2G with the second media content 260 presented in its content area 210.

In some embodiments, as shown in FIG. 2L, a notification interface 200L is configured to receive a notification. In response to the completion of processing of the generation request, in the notification interface 200L, a reminder message 293 is presented informing the user that the second media content 260 has been generated. The electronic device 110 may receive a ninth operation of the reminder message 293 by the user. For example, the electronic device 110 may receive a click or other suitable operation of the user on the reminder message 293, that is, receive a posting request. Accordingly, in response to receiving the ninth operation, the electronic device 110 may present the interface 200G as shown in FIG. 2G with the second media content 260 presented in its content area 210.

In some embodiments, as shown in FIG. 2M, an external interface 200M is an interface external to the application 120. In response to completion of the processing of the generation request, in the external interface 200M, the reminder message 293 is presented informing the user that the second media content 260 has been generated. The electronic device 110 may receive a ninth operation of the reminder message 293 by the user. For example, the electronic device 110 may receive a click or other suitable operation of the user on the reminder message 293, that is, receive a posting request. Accordingly, in response to receiving the ninth operation, the electronic device 110 may present the interface 200G as shown in FIG. 2G with the second media content 260 presented in its content area 210.

In some embodiments, the notification bar 291 and the reminder message 293 can immediately send a prompt to the user after the processing of generation request is completed, thereby improving the user experience. As an example, the notification bar 291 and the reminder message 293 may notify the completion in one or more forms such as text, picture, and dynamic information, which is not limited herein.

In some embodiments, the content generation method further includes: presenting a content item 295 associated with the first media content 230 in a personal page of the user; and presenting the processing state of the generation request in association with the content item 295.

In some embodiments, as shown in FIG. 2N, a personal page 200N is presented with a user's avatar 294 and a plurality of pieces of media contents, including the content item 295 associated with first media content 230. For example, if the generation request associated with the first media content 230 is not completed, the processing state of the generation request of the first media content 230 is indicated in a text form (e.g., ‘generating’).

In some embodiments, as shown in FIG. 2O, after the work corresponding to the dynamic media content and the second media content 260 are posted, the electronic device 110 may present a creation entry 296 in a viewing interface 200O of the work. The electronic device 110 may receive a tenth operation of the creation entry 296 by the user. For example, the electronic device 110 may receive a click or other suitable operation of the user on the creation entry 296, i.e., receive a posting request. Accordingly, in response to receiving the tenth operation, the electronic device 110 may present the interface 200G as shown in FIG. 2G with the second media content 260 presented in its content area 210.

Based on the foregoing process, in this way, on one hand, the creation entry 296 may be used as an identifier of the second media content 260 generated by using the foregoing content generation method, so that the user may distinguish and recognize. On the other hand, the user may directly edit the second media content 260 through the creation entry 296, thereby improving interaction attraction and convenience.

### Example Processes

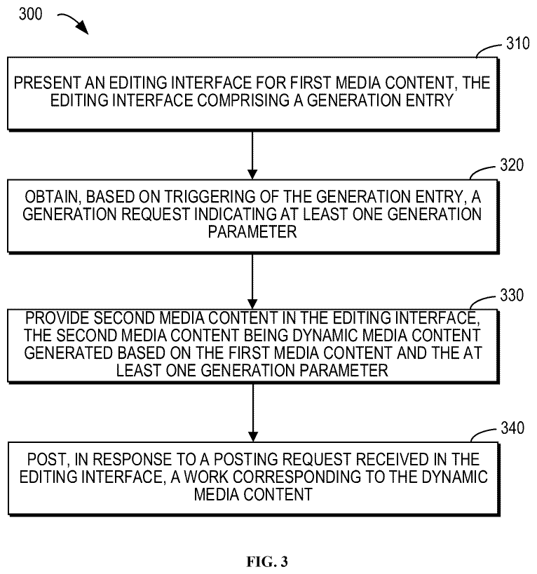

FIG. 3 illustrates a flowchart of an example process 300 of content generation according to some embodiments of the present disclosure. The process 300 may be implemented at electronic device 110. The process 300 is described below with reference to FIG. 1.

As shown in FIG. 3, at block 310, the electronic device 110 presents an editing interface for first media content, the editing interface comprising a generation entry.

At block 320, the electronic device 110 obtains a generation request based on triggering of the generation entry, a generation request indicating at least one generation parameter.

At block 330, the electronic device 110 provides second media content in the editing interface, the second media content being dynamic media content generated based on the first media content and the at least one generation parameter.

At block 340, the electronic device 110 posts a work corresponding to the dynamic media content in response to a posting request received in the editing interface.

In some embodiments, obtaining the generation request based on the triggering of the generation entry comprises: presenting an input control in response to a selection of the generation entry; and obtaining, via the input control, a prompt for generating the second media content.

In some embodiments, the process 300 further includes: updating, in response to obtaining the generation request, a style of the generation entry to indicate a processing state of the generation request.

In some embodiments, the process 300 further includes: presenting, before processing of the generation request is completed, state information in association with the generation entry, the state information indicating a duration of remaining processing of the generation request.

In some embodiments, the process 300 further includes: presenting a viewing panel before processing of the generation request is completed and in response to a selection of the generation entry, the viewing panel comprising at least one of: a first entry for triggering presentation of a draft viewing interface, or a second entry for triggering stopping of processing of the generation request.

In some embodiments, the process 300 further includes presenting, in the draft viewing interface, a processing state of a set of historical generation requests, the set of historical generation requests indicating generation of dynamic media content based on static media content, the set of historical generation requests comprising the generation request associated with the first media content.

In some embodiments, the process 300 further includes: receiving, in the editing interface and before processing of the generation request is completed, at least one edit operation independent of the generation request; and applying, in the editing interface, the at least one edit operation to the first media content.

In some embodiments, the process 300 further includes: applying, in response to completion of the processing of the generation request, the at least one edit operation to the generated second media content.

In some embodiments, the process 300 further includes: presenting a reminder message in response to completion of processing of the generation request; and presenting, in response to a predetermined operation on the reminder message, the generated second media content in the editing interface.

In some embodiments, the process 300 further includes: presenting, in a personal page of a user, a content item associated with the first media content; and presenting, in association with the content item, a processing state of the generation request.

In some embodiments, the generation request is processed asynchronously and processing of the generation request is independent of whether the editing interface is in an active state.

In some embodiments, process 300 further includes presenting, in a viewing interface of the work, a creation entry for triggering presentation of a creation interface associated with generation of dynamic media content.

### Example Apparatus and Device

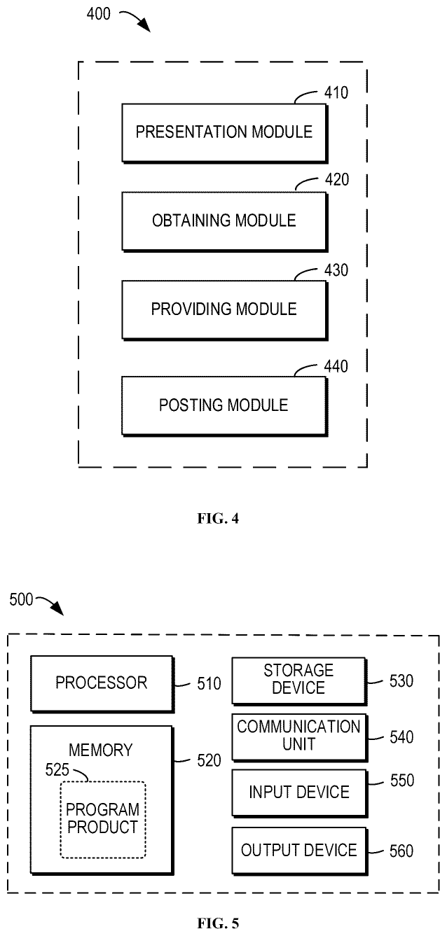

Embodiments of the present disclosure also provide a corresponding apparatus for implementing the above method or process. FIG. 4 shows a schematic structural block diagram of an example apparatus 400 for content generation according to some embodiments of the present disclosure. The apparatus 400 may be implemented or included in an electronic device. The various modules/components in the apparatus 400 may be implemented by hardware, software, firmware, or any combination thereof.

As shown in FIG. 4, the apparatus 400 includes a presentation module 410 configured to present an editing interface for first media content, the editing interface comprising a generation entry; an obtaining module 420 configured to obtain, based on triggering of the generation entry, a generation request indicating at least one generation parameter; a providing module 430 configured to provide second media content in the editing interface, the second media content being dynamic media content generated based on the first media content and the at least one generation parameter; and a posting module 430 configured to post, in response to a posting request received in the editing interface, a work corresponding to the dynamic media content.

In some embodiments, the obtaining module 420 is further configured to: present an input control in response to a selection of the generation entry; and obtain, via the input control, a prompt for generating the second media content.

In some embodiments, the apparatus 400 further includes a style module configured to update, in response to obtaining the generation request, a style of the generation entry to indicate a processing state of the generation request.

In some embodiments, the apparatus 400 further includes a state module configured to present, before processing of the generation request is completed, state information in association with the generation entry, the state information indicating a duration of remaining processing of the generation request.

In some embodiments, the apparatus 400 further includes an entry module configured to present a viewing panel before processing of the generation request is completed and in response to a selection of the generation entry, the viewing panel comprising at least one of: a first entry for triggering presentation of a draft viewing interface, or a second entry for triggering stopping of processing of the generation request.

In some embodiments, the apparatus 400 further includes a viewing module configured to present, in the draft viewing interface, a processing state of a set of historical generation requests, the set of historical generation requests indicating generation of dynamic media content based on static media content, the set of historical generation requests comprising the generation request associated with the first media content.

In some embodiments, the apparatus 400 further includes an editing module configured to receive, in the editing interface and before processing of the generation request is completed, at least one edit operation independent of the generation request; and applying, in the editing interface, the at least one edit operation to the first media content.

In some embodiments, the apparatus 400 further includes an application module configured to apply, in response to completion of the processing of the generation request, the at least one edit operation to the generated second media content.

In some embodiments, the apparatus 400 further includes a reminder module configured to present a reminder message in response to completion of processing of the generation request; and present, in response to a predetermined operation on the reminder message, the generated second media content in the editing interface.

In some embodiments, the apparatus 400 further includes a content module configured to present, in a personal page of a user, a content item associated with the first media content; and present, in association with the content item, a processing state of the generation request.

In some embodiments, the generation request is processed asynchronously and processing of the generation request is independent of whether the editing interface is in an active state.

In some embodiments, the apparatus 400 further includes a creation module configured to present, in a viewing interface of the work, a creation entry for triggering presentation of a creation interface associated with generation of dynamic media content.

The units included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the elements in the apparatus 400 may be implemented, at least in part, by one or more hardware logic components. By way of example and not limitation, exemplary types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 5 illustrates a block diagram of an electronic device 500 in which one or more embodiments of the present disclosure may be implemented. It should be understood that the electronic device 500 illustrated in FIG. 5 is merely exemplary and should not constitute any limitation on the functionality and scope of the embodiments described herein. The electronic device 500 shown in FIG. 5 may be used in an electronic device.

As shown in FIG. 5, the electronic device 500 is in the form of a general-purpose electronic device. Components of the electronic device 500 may include, but are not limited to, one or more processing units or processors 510, a memory 520, a storage device 530, one or more communication units 540, one or more input devices 550, and one or more output devices 560. The processor 510 may be an actual or virtual processor and capable of performing various processes according to programs stored in the memory 520. In multiprocessor systems, multiple processors execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for content generation, comprising:
presenting an editing interface for first media content, the editing interface comprising a generation entry;
obtaining, based on triggering of the generation entry, a generation request indicating at least one generation parameter;
providing second media content in the editing interface, the second media content being dynamic media content generated based on the first media content and the at least one generation parameter; and
posting, in response to a posting request received in the editing interface, a work corresponding to the dynamic media content.

2. The method of claim 1, wherein obtaining the generation request based on the triggering of the generation entry comprises:
presenting an input control in response to a selection of the generation entry; and
obtaining, via the input control, a prompt for generating the second media content.

3. The method of claim 1, further comprising:
updating, in response to obtaining the generation request, a style of the generation entry to indicate a processing state of the generation request.

4. The method of claim 3, further comprising:
presenting, before processing of the generation request is completed, state information in association with the generation entry, the state information indicating a duration of remaining processing of the generation request.

5. The method of claim 3, further comprising:
presenting a viewing panel before processing of the generation request is completed and in response to a selection of the generation entry, the viewing panel comprising at least one of:
a first entry for triggering presentation of a draft viewing interface, or
a second entry for triggering stopping of processing of the generation request.

6. The method of claim 5, further comprising:
presenting, in the draft viewing interface, a processing state of a set of historical generation requests, the set of historical generation requests indicating generation of dynamic media content based on static media content, the set of historical generation requests comprising the generation request associated with the first media content.

7. The method of claim 1, further comprising:
receiving, in the editing interface and before processing of the generation request is completed, at least one edit operation independent of the generation request; and
applying, in the editing interface, the at least one edit operation to the first media content.

8. The method of claim 7, further comprising:
applying, in response to completion of the processing of the generation request, the at least one edit operation to the generated second media content.

9. The method of claim 1, further comprising:
presenting a reminder message in response to completion of processing of the generation request; and
presenting, in response to a predetermined operation on the reminder message, the generated second media content in the editing interface.

10. The method of claim 1, further comprising:
presenting, in a personal page of a user, a content item associated with the first media content; and
presenting, in association with the content item, a processing state of the generation request.

11. The method of claim 1, wherein the generation request is processed asynchronously and processing of the generation request is independent of whether the editing interface is in an active state.

12. The method of claim 1, further comprising:
presenting, in a viewing interface of the work, a creation entry for triggering presentation of a creation interface associated with generation of dynamic media content.

13. An electronic device comprising:
at least one processor; and
at least one memory coupled to the at least one processor and storing instructions for execution by the at least one processor, the instructions, when executed by the at least one processor, causing the electronic device to perform operations comprising:
presenting an editing interface for first media content, the editing interface comprising a generation entry;
obtaining, based on triggering of the generation entry, a generation request indicating at least one generation parameter;
providing second media content in the editing interface, the second media content being dynamic media content generated based on the first media content and the at least one generation parameter; and
posting, in response to a posting request received in the editing interface, a work corresponding to the dynamic media content.

14. The electronic device of claim 13, wherein obtaining the generation request based on the triggering of the generation entry comprises:
presenting an input control in response to a selection of the generation entry; and
obtaining, via the input control, a prompt for generating the second media content.

15. The electronic device of claim 13, the operations further comprising:
updating, in response to obtaining the generation request, a style of the generation entry to indicate a processing state of the generation request.

16. The electronic device of claim 15, the operations further comprising:
presenting, before processing of the generation request is completed, state information in association with the generation entry, the state information indicating a duration of remaining processing of the generation request.

17. The electronic device of claim 15, the operations further comprising:
presenting a viewing panel before processing of the generation request is completed and in response to a selection of the generation entry, the viewing panel comprising at least one of:
a first entry for triggering presentation of a draft viewing interface, or
a second entry for triggering stopping of processing of the generation request.

18. The electronic device of claim 17, the operations further comprising:
presenting, in the draft viewing interface, a processing state of a set of historical generation requests, the set of historical generation requests indicating generation of dynamic media content based on static media content, the set of historical generation requests comprising the generation request associated with the first media content.

19. The electronic device of claim 13, the operations further comprising:
receiving, in the editing interface and before processing of the generation request is completed, at least one edit operation independent of the generation request; and
applying, in the editing interface, the at least one edit operation to the first media content.

20. A non-transitory computer-readable storage medium having a computer program stored thereon, the computer program executable by a processor to implement operations comprising:
presenting an editing interface for first media content, the editing interface comprising a generation entry;
obtaining, based on triggering of the generation entry, a generation request indicating at least one generation parameter;
providing second media content in the editing interface, the second media content being dynamic media content generated based on the first media content and the at least one generation parameter; and
posting, in response to a posting request received in the editing interface, a work corresponding to the dynamic media content.
